(19) United States
(12) Patent Application Publication
(10) Pub. No.: US 2014/0216397 A1
(43) Pub. Date: Aug. 7, 2014

(54) DIESEL ENGINE

(71) Applicant: Mazda Motor Corporation, Hiroshima (JP)

(72) Inventors: Shinya IIDA, Higashihiroshima-shi (JP); Sangkyu KIM, Higashihiroshima-shi (JP); Jun KANZAKI, Hiroshima-shi (JP); Takeshi YOKOO, Hiroshima-shi (JP)

(73) Assignee: MAZDA MOTOR CORPORATION, Hiroshima (JP)

(21) Appl. No.: 14/169,045

(22) Filed: Jan. 30, 2014

(30) Foreign Application Priority Data
Feb. 1, 2013 (JP) 2013-018824

(51) Int. Cl. F02M 61/14

(52) U.S. Cl. CPC F02M 61/14
USPC 123/299

(57) ABSTRACT

An injector of a diesel engine has a first injection valve and a second injection valve disposed to face each other with respect to the center of a combustion chamber. Assuming that a straight line passing through the first injection valve and the second injection valve is a symmetrical line, one of two regions obtained by dividing a planar region of a combustion chamber (3) into two along the symmetrical line is a first region, and the other of the two regions is a second region, the first injection valve injects fuel toward the first region, and the second injection valve injects fuel toward the second region. A cavity portion is formed in the top surface of a piston. The first injection valve and the second injection valve respectively have injection holes at radially inner positions than the periphery of the cavity portion in plan view.

### BACKGROUND OF THE INVENTION

1. Field of the Invention

The present invention relates to a diesel engine for diffusively combusting fuel injected from an injector in a combustion chamber.

2. Description of the Related Art

Japanese Unexamined Patent Publication No. 2007-231908 discloses a diesel engine of the above type. Specifically, the diesel engine disclosed in the Publication is provided with a pair of side injectors (a first side injector and a second side injector) on a periphery of the ceiling wall of a combustion chamber facing a top surface of a piston for directly injecting fuel into the combustion chamber.

The first and second side injectors are disposed to be directed toward the center of the combustion chamber, while facing each other. When the fuel is simultaneously injected from the paired side injectors, the injected fuel from the injectors collides with each other, and atomization of the fuel is promoted by the impact at the time of collision.

In the case where fuel injected from the paired side injectors collides with each other, however, a fuel-air mixture of a high fuel concentration is formed in the center part of the combustion chamber, and a fuel-air mixture of a low fuel concentration is formed in the peripheral part of the combustion chamber. As a result, the fuel distribution may be uneven. Uneven fuel distribution lowers the air utilization rate in the combustion chamber. This may result in an increase in the soot generation amount.

On the other hand, if the fuel injection directions from the paired side injectors are greatly away from each other with respect to the center of the combustion chamber, the aforementioned excessive increase in the fuel concentration in the center part of the combustion chamber can be avoided, because there is no or less likelihood that the injected fuel from the paired side injectors may collide with each other. However, an excessive increase in the distance between the injection direction and the center of the combustion chamber may cause collision of the injected fuel from the paired side injectors against a wall surface of a peripheral member such as a piston at a short distance. This may excessively increase the fuel concentration in a region other than the center part of the combustion chamber, and cause uneven fuel distribution. As a result, the air utilization rate may be lowered.

### SUMMARY OF THE INVENTION

In view of the above, an object of the invention is to provide a diesel engine that enables to enhance the air utilization rate in a combustion chamber for effectively reducing the soot generation amount.

An aspect of the invention is directed to a diesel engine provided with a combustion chamber formed between a reciprocating piston and a cylinder head; and an injector which injects fuel into the combustion chamber from the cylinder head side for diffusively combusting the fuel injected from the injector in the combustion chamber. The injector has a first injection valve and a second injection valve disposed to face each other with respect to a center of the combustion chamber. Assuming that a straight line passing through the first injection valve and the second injection valve is a symmetrical line, one of two regions obtained by dividing a planar region of the combustion chamber into two along the symmetrical line is a first region, and the other of the two regions is a second region, the first injection valve injects the fuel toward the first region, and the second injection valve injects the fuel toward the second region. A cavity portion is formed in a region on a top surface of the piston including a center part of the top surface, the cavity portion being concave toward a side opposite to the cylinder head. Each of the first injection valve and the second injection valve is formed with at least one injection hole at a radially inner position than a periphery of the cavity portion in plan view, the injection hole serving as an exit of the fuel.

### BRIEF DESCRIPTION OF THE DRAWINGS

FIG. 1 is a diagram showing an overall configuration of a diesel engine embodying the invention;

FIG. 2 is a cross-sectional view showing a structure of an engine main body of the diesel engine;

FIG. 3 is a diagram showing a shape of an intake port and an exhaust port of the diesel engine;

FIG. 4 is a cross-sectional view showing a structure of an injector (a first injection valve and a second injection valve) of the diesel engine;

FIG. 5 is a side view of a distal end of the injector (the first injection valve and the second injection valve);

FIG. 6 is a plan view for explaining a positional relationship between the first injection valve and the second injection valve, and a fuel injection direction from each of the injection valves;

FIG. 7 is a side view corresponding to FIG. 6;

FIG. 8 is a graph showing a relationship between a mass ratio of an over-rich air-fuel mixture formed in a combustion chamber by fuel injection from each of the injection valves, and a crank angle;

FIG. 9 is a graph showing a relationship between an amount of soot generated by combustion of fuel injected from each of the injection valves, and a crank angle;

FIG. 10 is a graph showing that making the sizes of injection holes of the injection valves different from each other leads to reduction of a soot generation amount;

FIG. 11 is a graph showing that making the sizes of injection holes of the injection valves different from each other leads to reduction of cooling loss;

FIG. 12 is a graph showing that fuel injection from each of the injection valves strengthens a swirl stream;

FIG. 13 is a diagram showing a state of fuel sprays in the case where fuel is injected from each of the injection valves at different angles; and

FIG. 14 is a diagram for explaining a modification of the embodiment.

### DESCRIPTION OF THE PREFERRED EMBODIMENTS

### (1) Overall Configuration of Engine

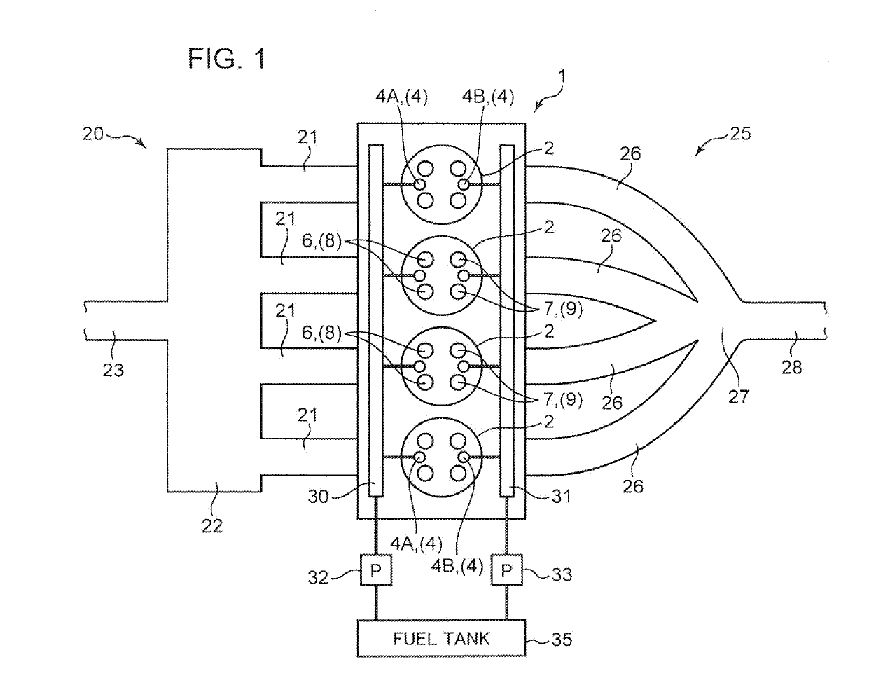

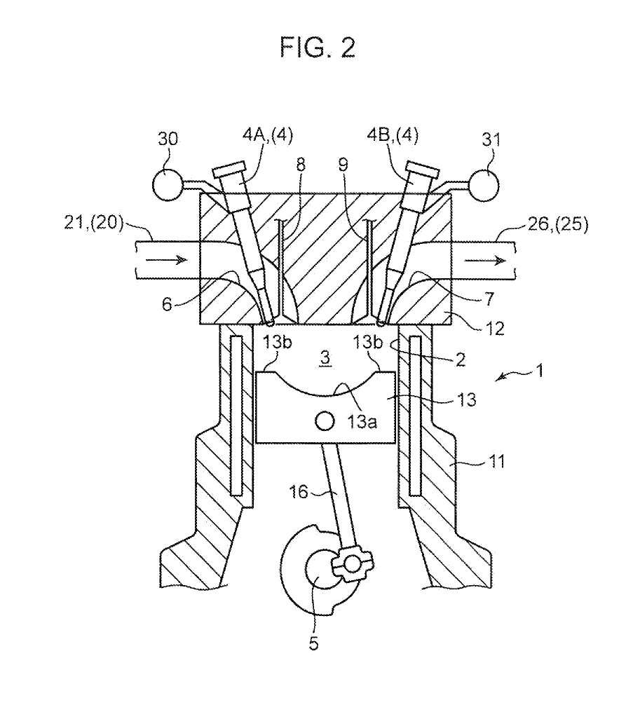

FIG. 1 and FIG. 2 show a diesel engine embodying the present invention. The diesel engine shown in FIG. 1 and FIG. 2 is a 4-cycle multi-cylinder diesel engine to be mounted on a vehicle, as a power source for driving. Specifically, the diesel engine is provided with an in-line four-cylinder engine main body 1 having linearly arranged four cylinders 2, an intake passage 20 through which air is drawn into the engine main body 1, and an exhaust passage 25 through which exhaust gas generated in the engine main body 1 is discharged.

As shown in FIG. 2, the engine main body 1 has a cylinder block 11, in which the four cylinders 2 are provided, a cylinder head 12 formed on a top surface of the cylinder block 11, and pistons 13, each of which is reciprocally and slidably inserted into the corresponding cylinder 2.

Each of the cylinders 2 is configured such that a circular combustion chamber 3 in plan view is formed at a position above the piston 13. In the combustion chamber 3, a fuel-air mixture is diffusively combusted, while fuel (light oil) to be injected from an injector 4 to be described later is mixed with air, and expansion energy by the combustion reciprocates the piston 13. The reciprocal motion of the piston 13 is converted into rotational motion of a crankshaft 5 as an output shaft via a connecting rod 16. The diesel engine in this embodiment is of four-cycle type. Accordingly, each of the cylinders 2 repeatedly performs four processes i.e. intake, compression, expansion, and exhaust processes in this order, as the crankshaft 5 is rotated.

A geometric compression ratio of each cylinder 2, i.e., a ratio between the volume of the combustion chamber 3 when the piston 13 is at a bottom dead center position, and the volume of the combustion chamber 3 when the piston 13 is at a top dead center position is set in the range of from 13 to 20. Further, the inner diameter (the bore diameter) of each cylinder 2 is set to be not larger than 100 mm

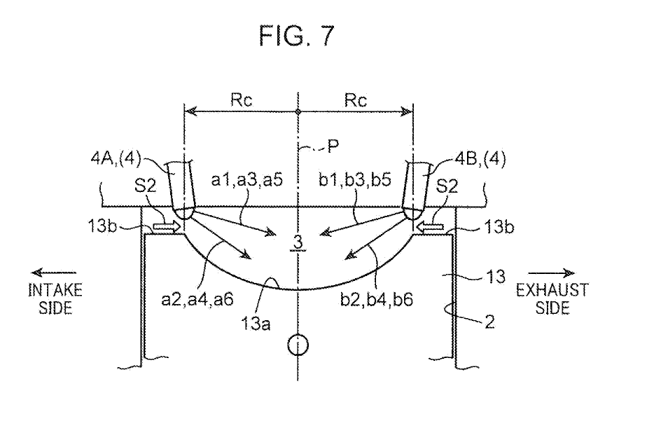

A top surface of the piston 13 has a cavity portion 13a concave toward the side opposite to the cylinder head 12, and a squish portion 13b formed around the cavity portion 13a. The cavity portion 13a is formed in a region on the top surface of the piston 13 including the center part of the top surface, and is formed into a cup shape such that the depth of the concave portion increases toward the center of the piston 13. The squish portion 13b is formed at a radially outer position than the cavity portion 13a, and is formed into an annular flat surface surrounding the cavity portion 13a. As shown in FIG. 7, the squish portion 13b has a function of generating a so-called squish stream (a stream of air flowing from the outer peripheral side of the combustion chamber 3 toward the center thereof, see the arrow S2 in FIG. 7) within the combustion chamber 3 when the piston 13 is moved up near the compression top dead center position.

As shown in FIG. 1 and FIG. 2, the cylinder head 12 is formed with an intake port 6 through which air to be supplied from the intake passage 20 is drawn into the combustion chamber 3 of each cylinder 2, an exhaust port 7 through which exhaust gas generated in the combustion chamber 3 of each cylinder 2 is drawn out, intake valves 8 which open and close a combustion chamber 3 side opening of the intake port 6, and exhaust valves 9 which open and close a combustion chamber 3 side opening of the exhaust port 7. Each of the intake valves 8 and the exhaust valves 9 is driven to be opened and closed in association with rotation of the crankshaft 5 of the engine main body 1 by a valve train mechanism (not shown) including a camshaft and a cam. In this embodiment, each of the cylinders 2 has two intake valves 8 and two exhaust valves 9.

The intake passage 20 has four independent intake passages 21, each of which communicates with the intake port 6 of the corresponding cylinder 2, a serge tank 22 commonly connected to upstream ends (upstream ends in the intake air flow direction) of the independent intake passages 21, and an intake pipe 23 extending from the serge tank 22 toward upstream.

The exhaust passage 25 has four independent exhaust passages 26, each of which communicates with the exhaust port 7 of the corresponding cylinder 2, a collecting portion 27 at which downstream ends (downstream ends in the exhaust gas flow direction) of the independent exhaust passages 26 are collected, and an exhaust pipe 28 extending from the collecting portion 27 toward downstream.

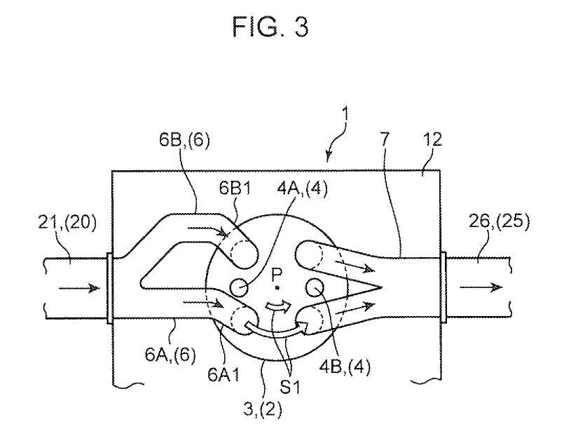

As shown in FIG. 3, the intake port 6 of each cylinder 2 is branched into a first port 6A and a second port 6B, each of which is configured to communicate between the downstream end of the corresponding independent intake passage 21 and the corresponding combustion chamber 3. The first port 6A has a curved portion 6A1 at a distal end thereof near the opening toward the combustion chamber 3. The curved portion 6A1 is curved in a direction other than the direction toward the center P of the combustion chamber 3, more specifically, is curved in a direction substantially orthogonal to a line segment connecting the opening of the first port 6A toward the combustion chamber 3, and the center P of the combustion chamber 3. On the other hand, the second port 6B has a curved portion 6B1 having substantially the same configuration as the curved portion 6A1 of the first port 6A except that the distal end of the curved portion 6B1 is directed to the center P of the combustion chamber 3.

According to the above configuration, intake air drawn in through the first port 6A forms a flow of air swirling around the outer periphery of the combustion chamber 3, and intake air drawn in through the second port 6B forms a flow of air swirling in the vicinity of the center P of the combustion chamber 3. As a result of formation of the airflows, a swirl stream Si swirling counterclockwise is formed in the whole space of the combustion chamber 3.

The injector 4 for directly injecting fuel (fuel containing light oil as a main ingredient) into the combustion chamber 3 of each cylinder 2 is provided at a position corresponding to each cylinder 2 in the cylinder head 12. The injector 4 of each cylinder 2 has a first injection valve 4A disposed at a position offset toward the intake side than the center P of the combustion chamber 2, and a second injection valve 4B disposed at a position offset toward the exhaust side than the center P of the combustion chamber 3.

The first injection valve 4A of each cylinder 2 is connected to a first common rail 30 commonly disposed to extend in the cylinder arrangement direction. Fuel to be fed from a first high-pressure pump 32, which is configured to pressurize and feed the fuel stored in a fuel tank 35, is stored in the first common rail 30 in a pressurized state. During operation of the engine, the high-pressure fuel stored in the first common rail 30 is injected from the first injection valve 4A, and is supplied to the combustion chamber 3 of each cylinder 2.

The fuel supply system to the second injection valve 4B is substantially the same as the first injection valve 4A. Specifically, the second injection valve 4B of each cylinder 2 is connected to a second common rail 31, which is commonly disposed to extend in the cylinder arrangement direction. Fuel to be fed from a second high-pressure pump 33, which is configured to pressurize and feed the fuel stored in the fuel tank 35, is stored in the second common rail 31 in a pressurized state. During operation of the engine, the high-pressure fuel stored in the second common rail 31 is injected from the second injection valve 4B, and is supplied to the combustion chamber 3 of each cylinder 2.

### (2) Example of Configuration of Injector

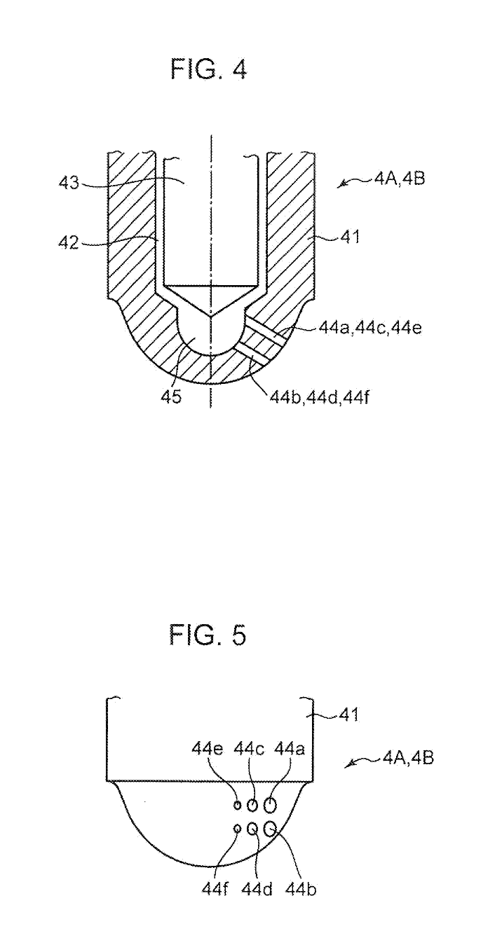

FIG. 4 is a cross-sectional view showing a structure of a distal end of the first injection valve 4A and the second injection valve 4B, and FIG. 5 is a side view of the distal end of the first injection valve 4A and the second injection valve 4B when viewed from a side (from one side in the cylinder arrangement direction). As shown in FIG. 4 and FIG. 5, each of the first and second injection valves 4A and 4B has a tubular valve body 41 internally formed with a fuel passage 42 through which fuel is allowed to flow, and a needle valve 43 disposed to advance and retract with respect to the fuel passage 42 of the valve body 41. A recess portion 45 continuing to a distal end of the fuel passage 42 is formed in the valve body 41. A plurality of injection holes 44a to 44f (in this embodiment, six injection holes) are formed in a distal end of the valve body 41 to communicate between the recess portion 45 and the distal end surface of the valve body 41. During operation of the engine, the needle valve 43 is driven to advance and retract by a driving force of an unillustrated solenoid. According to the above configuration, communication between the fuel passage 42 and the recess portion 45 is cut off, or the cut-off state is released, as the needle valve 43 is advanced or retracted. During a period of time when the needle valve 43 is retracted (during a period of time when the fuel passage 42 and the recess portion 45 communicate with each other), fuel is injected through the injection holes 44a to 44f. FIG. 4 shows a cross section of a state that the needle valve 43 is retracted (in other words, a state that fuel is injected).

All the six injection holes 44a to 44f are disposed in one of the four regions obtained by dividing the distal end surface of the substantially hemispherical valve body 41 into four. More specifically, in the embodiment, the six injection holes 44a to 44f are arranged in two rows by three columns In this example, the injection holes 44a, 44c, and 44e are formed in the upper row in this order from one side in a circumferential direction of the valve body 41, and the injection holes 44b, 44d, and 44f are formed in the lower row in this order from the one side in the circumferential direction of the valve body 41. The injection holes 44a and 44b are aligned at the same position in the circumferential direction, the injection holes 44c and 44d are aligned at the same position in the circumferential direction, and the injection holes 44e and 44f are aligned at the same position in the circumferential direction.

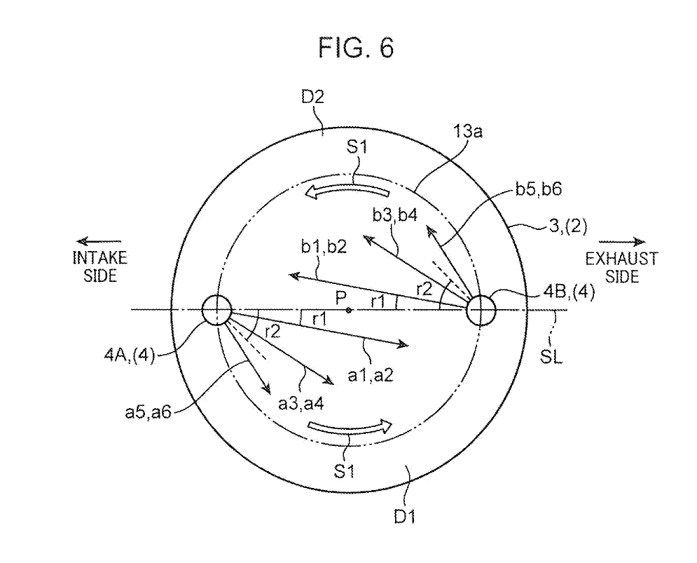

In the following, a positional relationship between the first injection valve 4A and the second injection valve 4B in each cylinder 2 is described referring to the schematic diagrams of FIG. 6 and FIG. 7. FIG. 6 is a plan view of the first and second injection valves 4A and 4B of one of the cylinders 2 when viewed from the ceiling side of the combustion chamber 3. FIG. 7 is a side view of the combustion chamber 3 in a state that the piston 13 of the cylinder 2 is moved up to the compression top dead center position. Referring to FIG. 6, the periphery of the cavity portion 13a formed in the top surface of the piston 13, in other words, the borderline between the cavity portion 13a and the squish portion 13b surrounding the cavity portion 13a are indicated by the two-dotted chain line. Referring to FIG. 7, the radius of the periphery of the cavity portion 13a is indicated by the symbol “Rc”.

As shown in FIG. 6 and FIG. 7, the distal end of the first injection valve 4A is disposed at a position on the ceiling portion (the lower wall of the cylinder head 12) of the combustion chamber 3, which is offset toward the intake side than the center P of the combustion chamber 3 by the radius Rc of the cavity portion 13a. In other words, the center of the distal end of the first injection valve 4A is set to a position facing a point closest to the intake side on the periphery of the cavity portion 13a.

On the other hand, the distal end of the second injection valve 4B is disposed at a position obtained by rotating the first injection valve 4A by 180° around the center P of the combustion chamber 3 in plan view when viewed from the ceiling side of the combustion chamber 3, that is, at a position symmetrical to the first injection valve 4A with respect to the center P of the combustion chamber 3. In other words, the center of the distal end of the second injection valve 4B is set to a position facing a point closest to the exhaust side on the periphery of the cavity portion 13a.

Referring to FIG. 6 and FIG. 7, arrows a1 to a6 extending from the first injection valve 4A respectively represent fuel sprays injected through the six injection holes 44a to 44f (see FIG. 4 and FIG. 5) formed in the distal end of the first injection valve 4A, more specifically, the centerlines of fuel sprays. Likewise, arrows b1 to b6 extending from the second injection valve 4B respectively represent fuel sprays injected through the six injection holes 44a to 44f formed in the distal end of the second injection valve 4B, more specifically, the centerlines of fuel sprays.

Specifically, regarding the first injection valve 4A, a fuel spray through the injection hole 44a is represented by a1, a fuel spray through the injection hole 44b is represented by a2, a fuel spray through the injection hole 44c is represented by a3, a fuel spray through the injection hole 44d is represented by a4, a fuel spray through the injection hole 44e is represented by a5, and a fuel spray through the injection hole 44f is represented by a6. In the plan view of FIG. 6, fuel sprays through the injection holes aligned at the same position in the circumferential direction appear to overlap each other. Accordingly, the group of a1 and a2, the group of a3 and a4, and the group of a5 and a6 are indicated to overlap each other. Further, in the side view of FIG. 7, fuel sprays through the injection holes aligned at the same position in the up and down direction appear to overlap each other. Accordingly, the group of a1, a3 and a5, and the group of a2, a4, and a6 are indicated to overlap each other.

Further, regarding the second injection valve 4B, a fuel spray through the injection hole 44a is represented by b1, a fuel spray through the injection hole 44b is represented by b2, a fuel spray through the injection hole 44c is represented by b3, a fuel spray through the injection hole 44d is represented by b4, a fuel spray through the injection hole 44e is represented by b5, and a fuel spray through the injection hole 44f is represented by b6. In the plan view of FIG. 6, fuel sprays through the injection holes aligned at the same position in the circumferential direction appear to overlap each other. Accordingly, the group of b1 and b2, the group of b3 and b4, and the group of b5 and b6 are indicated to overlap each other. Further, in the side view of FIG. 7, fuel sprays through the injection holes aligned at the same position in the up and down direction appear to overlap each other. Accordingly, the group of b1, b3 and b5, and the group of b2, b4, and b6 are indicated to overlap each other.

Referring to FIG. 6, let it be assumed that a line passing through the center of the first injection valve 4A and the center of the second injection valve 4B is a symmetrical line SL. Further, let it be assumed that one of two regions obtained by dividing a planar region of the combustion chamber 3 into two along the symmetrical line SL is a first region D1, and the other of the two regions is a second region D2.

The first injection valve 4A injects fuel in a radial fashion toward the first region D1 through the six injection holes 44a to 44f formed in the distal end of the first injection valve 4A. On the other hand, the second injection valve 4B injects fuel in a radial fashion toward the second region D2 through the six injection holes 44a to 44f formed in the distal end of the second injection valve 4B. By the above operation, the fuel sprays a1 to a6 to be injected from the first injection valve 4A, and the fuel sprays b1 to b6 to be injected from the second injection valve 4B are configured to extend in directions offset from each other so that the fuel sprays do not intersect with each other during injection.

Further, as shown in FIG. 6 and FIG. 7, the first and second injection valves 4A and 4B are disposed to inject fuel from a radially inner position (from the center side of the combustion chamber 3) than the periphery of the cavity portion 13a in plan view. Specifically, all the injection holes 44a to 44f in the first injection valve 4A as the exits of the fuel sprays a1 to a6, and all the injection holes 44a to 44f in the second injection valve 4B as the exits of the fuel sprays b1 to b6 are opened at radially inner positions than the periphery of the cavity portion 13a. Accordingly, each of the fuel sprays (a1 to a6, and b1 to b6) from the first and second injection valves 4A and 4B is injected toward the inner space of the cavity portion 13a without colliding against the squish portion 13b of the piston 13.

The fuel spray closest to the symmetrical line SL, out of the six fuel sprays a1 to a6 to be injected from the first injection valve 4A, is the fuel sprays a1 and a2 through the injection holes 44a and 44b. Assuming that the angle (fuel spray angle) defined by the centerline of the fuel spray a1 (a2), and the symmetrical line SL is r1, the fuel spray angle r1 is set to be not smaller than 7° but not larger than 15°.

Further, the fuel spray second closest to the symmetrical line SL, out of the six fuel sprays a1 to a6 to be injected from the first injection valve 4A, is the fuel sprays a3 and a4 through the injection holes 44c and 44d. Furthermore, the fuel spray farthest from the symmetrical line SL is the fuel sprays a5 and a6 through the injection holes 44e and 44f. Assuming that the average of these fuel spray angles, specifically, the average fuel spray angle obtained by averaging the angle defined by the centerline of the fuel spray a3 (a4), and the symmetrical line SL; and the angle defined by the centerline of the fuel spray a5 (a6), and the symmetrical line SL is r2, the average fuel spray angle r2 is set to be 45±10°.

The same is also true for the second injection valve 4B. Specifically, the fuel spray closest to the symmetrical line SL, out of the six fuel sprays b1 to b6 to be injected from the second injection valve 4B, is the fuel sprays b1 and b2 through the injection holes 44a and 44b. The angle defined by the centerline of the fuel spray b1 (b2), and the symmetrical line SL is also set to r1 (where r1 is not smaller than 7° but not larger than 15°), as well as the fuel spray angle of the fuel spray a1 (a2).

Further, the fuel spray second closest to the symmetrical line SL, out of the six fuel sprays b1 to b6 to be injected from the second injection valve 4B, is the fuel sprays b3 and b4 through the injection holes 44c and 44d. Furthermore, the fuel spray farthest from the symmetrical line SL is the fuel sprays b5 and b6 through the injection holes 44e and 44f. The average of these fuel spray angles, specifically, the average fuel spray angle r2 obtained by averaging the angle defined by the centerline of the fuel spray b3 (b4), and the symmetrical line SL; and the angle defined by the centerline of the fuel spray b5 (b6), and the symmetrical line SL is also set such that r2 (=45±10°), as well as the average fuel spray angle of the fuel sprays a3 to a6.

As shown in FIG. 6, the directions of the fuel sprays a1 to a6 from the first injection valve 4A, and the directions of the fuel sprays b1 to b6 from the second injection valve 4B are respectively configured to align along the swirl stream S1 to be formed in the combustion chamber 3. Specifically, referring to FIG. 6, the swirl stream S1 swirling counterclockwise in the combustion chamber 3 in plan view is formed. Accordingly, the swirl stream S1 is allowed to flow rightwardly (from the left to the right) in the first region D1 of the combustion chamber 3, and is allowed to flow leftwardly (from the right to the left) in the second region D2 of the combustion chamber 3. On the other hand, the fuel sprays a1 to a6 from the first injection valve 4A are injected rightwardly in the first region D1 as well as the swirl stream S1 in the first region D1, and the fuel sprays b1 to b6 from the second injection valve 4B are injected leftwardly in the second region D2 as well as the swirl stream S1 in the second region D2.

As shown in FIG. 5, the six injection holes 44a to 44f in each of the first and second injection valves 4A and 4B are formed such that the hole diameter decreases, as the distance from the symmetrical line SL to the corresponding fuel spray increases. Specifically, the diameter of the injection hole 44c, 44d corresponding to the fuel spray a3, a4 (or b3, b4) second closest to the symmetrical line SL is set to be smaller than the diameter of the injection hole 44a, 44b corresponding to the fuel spray a1, a2 (or b1, b2) closest to the symmetrical line SL; and the diameter of the injection hole 44e, 44f corresponding to the fuel spray a5, a6 (or b5, b6) farthest from the symmetrical line SL is set to be smaller than the diameter of the injection hole 44c, 44d.

### (3) Advantageous Effects Etc.

As described above, in the embodiment, the diesel engine configured to diffusively combust fuel by injecting the fuel from the injector 4 into the combustion chamber 3 formed between the piston 3 and the cylinder head 12 has the following configuration.

The injector 4 has, in plan view when viewed from the ceiling side (from the cylinder head 12 side) of the combustion chamber 3, the first injection valve 4A provided in the periphery of the combustion chamber 3, and the second injection valve 4B provided at a position symmetrical to the first injection valve 4B with respect to the center P of the combustion chamber 3. Assuming that a straight line passing through the first injection valve 4A and the second injection valve 4B is the symmetrical line SL, one of two regions obtained by dividing the planar region of the combustion chamber 3 into two along the symmetrical line SL is the first region D1, and the other of the two regions is the second region D2, the first injection valve 4A injects fuel toward the first region D1, and the second injection valve 4B injects fuel toward the second region D2. The cavity portion 13a is formed in a region on the top surface of the piston 13 including the center part of the top surface, and is concave toward the side opposite to the cylinder head 12. The injection holes 44a to 44f formed in each of the first injection valve 4A and the second injection valve 4B are formed at radially inner positions than the periphery of the cavity portion 13a in plan view.

The above configuration is advantageous in enhancing the air utilization rate in the combustion chamber 3 to thereby effectively reduce the soot generation amount.

Specifically, in the embodiment, fuel is injected from the first injection valve 4A and the second injection valve 4B disposed to face each other with respect to the center P of the combustion chamber 3 toward the two regions (the first region D1 and the second region D2) divided by the symmetrical line SL connecting the first and second injection valves 4A and 4B. Accordingly, unlike a general diesel engine configured to inject fuel in a radial fashion from a single injection valve disposed at the center P of the combustion chamber 3 toward the periphery of the combustion chamber 3, the above configuration makes it possible to extend a flight distance by which the injected fuel sprays (particularly, the fuel sprays a1 and a2, and the fuel sprays b1 and b2 closest to the symmetrical line SL) can fly, in other words, to extend the distance connecting the exit (the injection hole) of a fuel spray and the wall surface of the piston 13 along the centerline of the fuel spray.

In particular, in the embodiment, the cavity portion 13a concave toward the side opposite to the cylinder head 12 is formed in the top surface of the piston 13, and the injection holes 44a to 44f are formed in each of the first and second injection valves 4A and 4B at radially inner positions than the periphery of the cavity portion 13a. This configuration makes it possible to avoid collision of fuel sprays through the injection holes 44a to 44f against the peripheral wall surface (the squish portion 13b) outside of the cavity portion 13a at a very small distance. Further, as shown in FIG. 7, the above configuration makes it possible to let the fuel sprays (a1 to a6, and b1 to b6) injected through the injection holes 44a to 44f to fly along the wall surface of the cavity portion 13a. This makes it possible to extend the flight distance of fuel sprays.

As described above, securing a long flight distance of the fuel sprays (a1 to a6, and b1 to b6) from the first and second injection valves 4A and 4B makes it possible to sufficiently atomize the fuel during flight of the fuel sprays, and thereby to weaken the penetration of the fuel sprays. Accordingly, it is possible to avoid that strong collision of fuel sprays against the wall surface of the piston 13 results in uneven fuel distribution. As a result of the above operation, the air utilization rate in the combustion chamber 3 is enhanced. This is advantageous in suppressing combustion in an oxygen lean environment to thereby effectively reduce the soot generation amount.

Further, the first and second injection valves 4A and 4B are disposed at two positions facing each other on the periphery of the combustion chamber 3. This makes it possible to inject fuel of a desired amount in a distributed manner from the different positions, and to constantly supply air around the injection holes in the first and second injection valves 4A and 4B by the swirl stream S1 swirling around within the combustion chamber 3. Accordingly, an air shortage state in the initial stage of combustion when the fuel has just started to be injected from the first and second injection valves 4A and 4B is eliminated, and fuel and air are sufficiently mixed. In this manner, a sufficient amount of air is secured even in an initial stage of combustion when an air shortage state is likely to occur. Thus, it is possible to achieve combustion with less soot generation and enhanced emission performance.

Further, weakening the penetration of fuel sprays and enhancing the air utilization rate as described above is advantageous in reducing the cooling loss of an engine and in enhancing the thermal efficiency.

Cooling loss is generated by absorption of thermal energy by combustion through the wall surface of the combustion chamber 3. Thermal energy absorbed through a wall surface mainly depends on three factors (i) the surface area of a heat transfer section, which is a contact part between a wall surface and flame, (ii) the flow velocity on a heat transfer section, and (iii) the flame temperature. Specifically, as (i) the surface area of a heat transfer section increases, the cooling loss increases, as (ii) the flow velocity on a heat transfer section increases, the cooling loss increases, and as (iii) the flame temperature increases, the cooling loss increases.

On the other hand, in the embodiment, the penetration is weakened because a long flight distance of fuel sprays is secured. This avoids spread of flame at a tip end of a fuel spray along the wall surface of the piston 13, and as a result, the surface area of a heat transfer section is decreased, and the flow velocity on the heat transfer section is lowered. In addition to the above, since relatively lean combustion with a high air utilization rate is implemented, the flame temperature is lowered. As described above, all the factors (i) to (iii) are changed in a direction of reducing the cooling loss. As a result of the synergetic effect of these factors, the thermal efficiency is enhanced, and the fuel efficiency is improved.

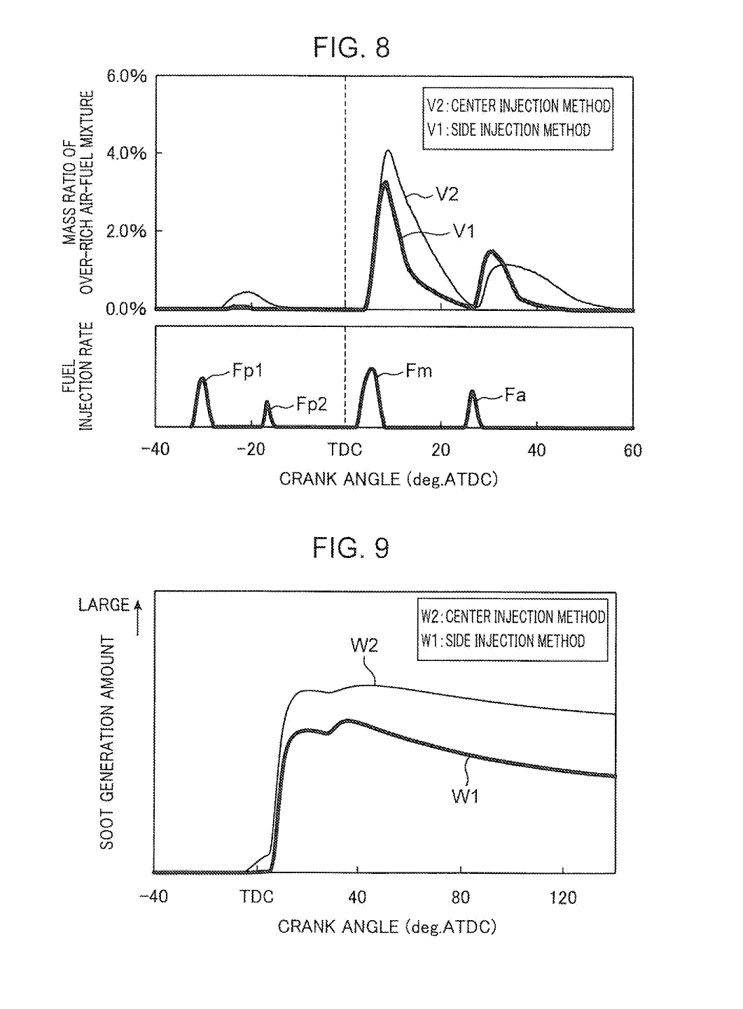

In the following, the mechanism as to how the injection valve disposition method of the embodiment is advantageous in suppressing the soot generation amount is described in details referring to FIG. 8 and FIG. 9.

FIG. 8 is a graph showing a mass ratio of an over-rich air-fuel mixture (in this embodiment, a mixture whose equivalent ratio Φ exceeds 2) formed in the combustion chamber 3, in the case where fuel is injected at a predetermined injection pattern. Referring to FIG. 8, the bold solid line waveform V1 represents a ratio of an over-rich air-fuel mixture, in the case where the injection valves are disposed as described in the embodiment (in other words, in the case where the first and second injection valves 4A and 4B are disposed to face each other with respect to the center P of the combustion chamber 3, hereinafter, this configuration is called as a side injection method). The thin solid line waveform V2 represents a ratio of an over-rich air-fuel mixture, in the case where a single injection valve is disposed in the center P of the combustion chamber 3 (hereinafter, this configuration is called as a center injection method). In the case of the center injection method, fuel is injected in a radial fashion toward the periphery of the combustion chamber 3 from a single injection valve having twelve injection holes, whose number is equal to the sum of the numbers of the injection holes in the first and second injection valves 4A and 4B in the embodiment. Further, the injection pattern is the same between the side injection method and the center injection method. In the example of the graph shown in FIG. 8, two pre-injections Fp1 and Fp2 are performed before the piston reaches the compression top dead center position (the TDC position on the horizontal axis), a main injection Fm is performed immediately after the piston reaches the compression top dead center position, and then, an after injection Fa is performed after the main injection Fm.

As shown in FIG. 8, it is obvious that the average mass ratio of an over-rich air-fuel mixture is smaller in the case where the side injection method of injecting fuel from the first and second injection valves 4A and 4B facing each other with respect to the center P of the combustion chamber 3 is performed, than in the case where the center injection method of injecting fuel from a single injection valve disposed in the center P of the combustion chamber 3 is performed. In particular, regarding the over-rich air-fuel mixture formed immediately after the main injection Fm whose fuel injection amount is largest, the peak value of the mass ratio of the over-rich air-fuel mixture is smaller, and the decay rate of the over-rich air-fuel mixture after the mass ratio has reached the peak is faster, in the case where the side injection method is performed than in the case where the center injection method is performed. Further, regarding the over-rich air-fuel mixture formed immediately after the after injection Fa, although the peak value of the mass ratio of the over-rich air-fuel mixture is slightly higher in the case where the side injection method is performed, the decay rate afterwards is faster in the case where the side injection method is performed. Thus, the average mass ratio of an over-rich air-fuel mixture is smaller in the case where the side injection method is performed than in the case where the center injection method is performed.

FIG. 9 is a graph showing a comparison between the side injection method and the center injection method, regarding the amount of soot generated in combusting fuel injected with the injection pattern shown in FIG. 8. The bold solid line waveform W1 represents a soot generation amount in the case where the side injection method is performed, and the thin solid line waveform W2 represents a soot generation amount in the case where the center injection method is performed. As shown in FIG. 9, it is obvious that the soot generation amount is smaller in the whole period of time after the piston 13 reaches the compression top dead center (TDC) position in the case where the side injection method is performed than in the case where the center injection method is performed. This is because, as shown in FIG. 8, implementing the side injection method is advantageous in lowering the overall mass ratio of an over-rich air-fuel mixture (a mixture whose equivalent ratio Φ exceeds 2). Specifically, taking into account a fact that soot is likely to be generated in a high fuel concentration region (where air is lean), the soot generation amount is suppressed by employing the side injection method, because the side injection method is capable of suppressing the mass ratio of an over-rich air-fuel mixture.

As described referring to FIG. 5 etc., in the embodiment, the injection holes 44a to 44f in the first and second injection valves 4A and 4B are formed to have a smaller hole diameter, as the distance from the symmetrical line SL to the corresponding fuel spray increases. More specifically, the hole diameter is set to be smaller in the order of the injection holes 44a and 44b corresponding to the fuel sprays a1 and a2 (or b1 and b2) closest to the symmetrical line SL, the injection holes 44c and 44d corresponding to the fuel sprays a3 and a4 (or b3 and b4) second closest to the symmetrical line SL, and the injection holes 44e and 44f corresponding to the fuel sprays a5 and a6 farthest from the symmetrical line SL (44a =44b >44c =44d >44e =44f). According to the above configuration, as the distance (the flight distance) between the exit of the fuel spray and the wall surface of the piston 13 is shortened, the injection hole as the exit of the fuel spray is formed to be smaller to thereby weaken the penetration. Thus, the above configuration makes it possible to avoid strong collision of all the fuel sprays against the wall surface of the piston 13, and makes it possible to make the fuel distribution even. This is advantageous in reducing the soot generation amount.

Specifically, the fuel sprays (a1, a2, b1, and b2) closest to the symmetrical line SL has a longest flight distance, i.e., a longest distance between the exit (the injection holes 44a and 44b) of a fuel spray and the wall surface of the piston 13 along the centerline of the fuel spray. This makes it possible to sufficiently weaken the penetration during flight of the fuel sprays. Accordingly, even if the injection holes 44a and 44b corresponding to the fuel sprays have a large diameter (in other words, even if the injection amount through the injection holes 44a and 44b is large), it is possible to avoid strong collision of fuel sprays against the piston 13. On the other hand, although the flight distance of the fuel sprays (a5, a6, b5, and b6) farthest from the symmetrical line SL is short, the injection holes 44e and 44f corresponding to the fuel sprays have a small diameter (in other words, the injection amount through the injection holes 44e and 44f is small). Accordingly, the inherent penetration is weak, and it is also possible to avoid collision of fuel sprays against the piston 13.

As described above, the configuration of the embodiment makes it possible to sufficiently weaken the penetration of the center-side fuel sprays (a1, a2, b1, and b2) during injection, while securing injection of a large amount of fuel through the center-side fuel sprays. Accordingly, the inherent penetration of the outer-side fuel sprays (particularly, a5, a6, b5, and b6) can be weakened by reducing the injection amount of the outer-side fuel sprays. As a result of the above operation, it is possible to sufficiently suppress collision of all the fuel sprays against the piston 13.

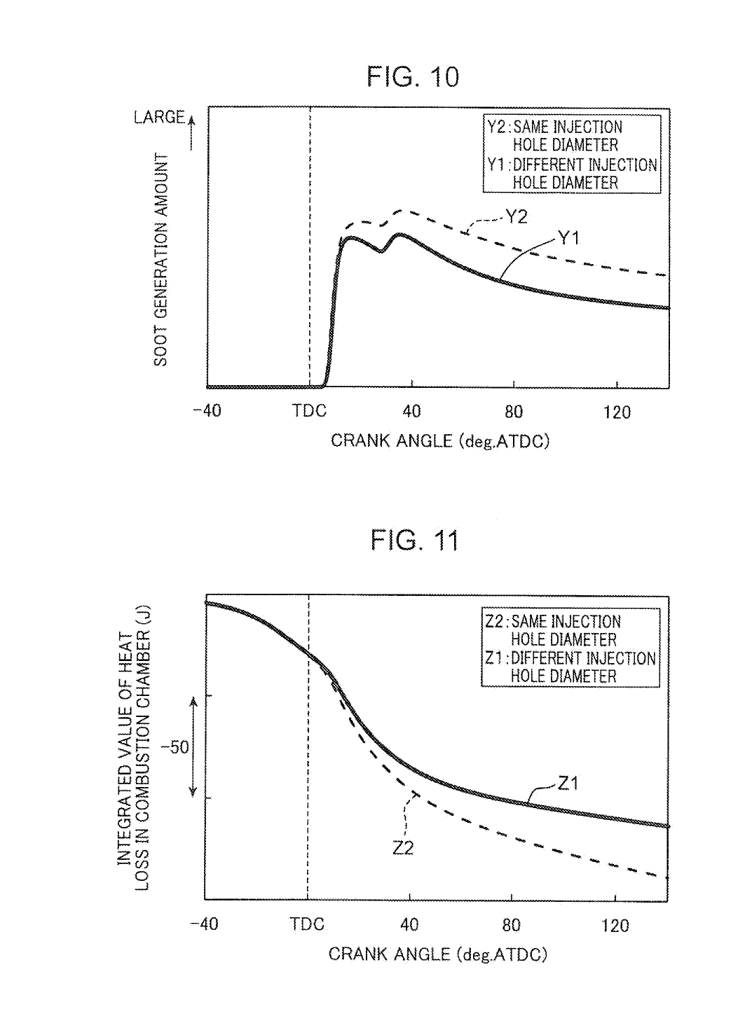

FIG. 10 is a graph showing a comparison between a soot generation amount (indicated by the solid line waveform Y1) in the case where the injection hole diameters are made different from each other as described above, and a soot generation amount (indicated by the broken line waveform Y2) in the case where the injection hole diameters are made equal to each other. In the latter case, the hole diameters of all the injection holes are set to be about 0.1 mm. In the former case, hole diameters of three sizes are set i.e. the hole diameter of about 0.1 mm, the hole diameter of a size larger than the size of the aforementioned hole diameter by about 22%, and the hole diameter of a size smaller than the size of the aforementioned hole diameter by about 30%. As is obvious from FIG. 10, in the case where the hole diameter is set to be smaller, as the fuel spray is farther away from the symmetrical line SL, the soot generation amount is reduced, as compared with a case, in which the hole diameters are made equal to each other. This is because the former case in which the hole diameters are made different from each other is advantageous in effectively suppressing collision of fuel sprays against the piston 13 to thereby enhance the air utilization rate.

FIG. 11 is a graph showing a comparison between cooling loss (indicated by the solid line waveform Z1) in the case where the injection hole diameters are made different from each other, and cooling loss (indicated by the broken line waveform Z2) in the case where the injection hole diameters are made equal to each other. The vertical axis in the graph of FIG. 11 denotes an integrated value of heat loss in a combustion chamber. As the integrated value is lowered on the vertical axis, the cooling loss is increased. As is obvious from FIG. 11, in the case where the hole diameter is set to be smaller, as the fuel spray is farther away from the symmetrical line SL, the cooling loss is reduced, as compared with a case, in which the hole diameters are made equal to each other. This is because the former case of making the hole diameters different from each other is advantageous in sufficiently suppressing collision of fuel sprays against the wall surface. As a result of the above operation, it is possible to reduce the surface area of a heat transfer section and to reduce the fluid velocity on the heat transfer section, and it is further possible to enhance the air utilization rate to thereby lower the flame temperature.

As shown in FIG. 2 and FIG. 7, in the embodiment, the squish portion 13b formed of an annular flat surface is formed on the outer periphery of the piston 13 at a radially outer position than the cavity portion 13a. According to the above configuration, when the piston 13 is moved up near the compression top dead center position, it is possible to form a squish stream S2 (see FIG. 7) directing from the outer peripheral side of the combustion chamber 3 toward the center of the combustion chamber 3. The squish stream S2 is operative to push the swirl stream S1 swirling around within the combustion chamber 3 toward the center of the combustion chamber 3. This is further advantageous in strengthening the swirl stream S1. Further, the squish stream S2 is operative to push back the fuel sprays that have been injected from the first and second injection valves 4A and 4B and may come close to the wall surface of the piston 13 (the periphery of the cavity portion 13a). This makes it possible to suppress collision of fuel sprays against the wall surface of the piston 13. Thus, the synergetic effect of the swirl stream Si and the squish stream S2 promotes mixing of fuel and air to thereby further enhance the air utilization rate.

In particular, in the embodiment, the average fuel spray angle r2 of the remaining fuel spray group (a3 to a6, and b3 to b6) other than the fuel sprays (a1, a2, b1, and b2) closest to the symmetrical line SL, out of the fuel sprays from the first and second injection valves 4A and 4B, is set to be 45±10° with respect to the symmetrical line SL. The above configuration is further advantageous in strengthening the swirl stream S1 swirling around within the combustion chamber 3, and in promoting mixing of fuel and air.

Specifically, the remaining fuel spray group (a3 to a6, and b3 to b6) to be injected from the first and second injection valves 4A and 4B contains a large amount of tangential vector components in a direction orthogonal to the symmetrical line SL. Accordingly, the remaining fuel spray group is operative to strengthen the swirl stream S1 swirling around within the combustion chamber 3. However, an excessive decrease in the angle (fuel spray angle) of the remaining fuel spray group reduces the amount of tangential vector components, which may make it difficult to obtain a sufficient effect of strengthening the swirl stream S1. On the other hand, an excessive increase in the fuel spray angle may shorten the flight distance from the exit of a fuel spray (the injection holes 44c to 44f) to the wall surface of the piston 13. This may cause strong collision of fuel sprays against the piston 13. In contrast, in the case where the average value (average fuel spray angle) r2 of the angles of the remaining fuel spray group is set to be 45±10°, it is possible to sufficiently strengthen the swirl stream S1, while avoiding collision of fuel sprays against the piston 13 as described above. Thus, the above configuration is advantageous in enhancing the air utilization rate.

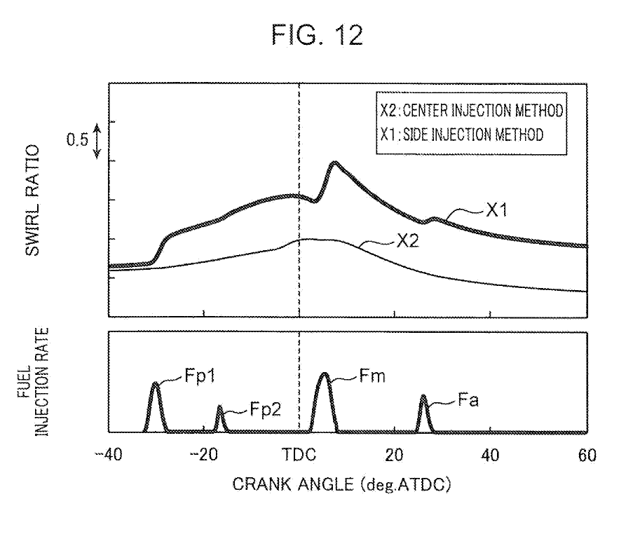

FIG. 12 is a graph showing a comparison between the side injection method and the center injection method, regarding the strength of the swirl stream S1 to be formed in the combustion chamber 3 (more specifically, a swirl ratio, which is a ratio of the angular velocity of a swirl stream with respect to the angular velocity of a crankshaft). The bold solid line waveform X1 represents a swirl ratio in the case where the side injection method is performed, and the thin solid line waveform X2 represents a swirl ratio in the case where the center injection method is performed. Referring to FIG. 12, in the case where the side injection method is performed, the average fuel spray angle r2 is set to be 45°. More specifically, the fuel spray angle of the fuel sprays a3, a4, b3, and b4 is set to be 35°, and the fuel spray angle of the fuel sprays a5, a6, b5, and b6 is set to be 55°.

As shown in FIG. 12, it is obvious that the swirl ratio is remarkably increased in the case where the side injection method of injecting fuel from the first and second injection valves 4A and 4B facing each other with respect to the center P of the combustion chamber 3 is performed, as compared with the case where the center injection method of injecting fuel in a radial fashion from the center P of the combustion chamber 3 is performed. This is because, as described above, the swirl stream S1 is strengthened by the squish stream S2, and because of the operation of the fuel sprays a3 to a6, and b3 to b6 whose average fuel spray angle r2 is 45±10°. In contrast to the above, the swirl ratio is not increased in the case where the center injection method is performed, because in the center injection method of injecting fuel in a radial fashion from the center P of the combustion chamber 3, momenta of the fuel sprays are cancelled out each other.

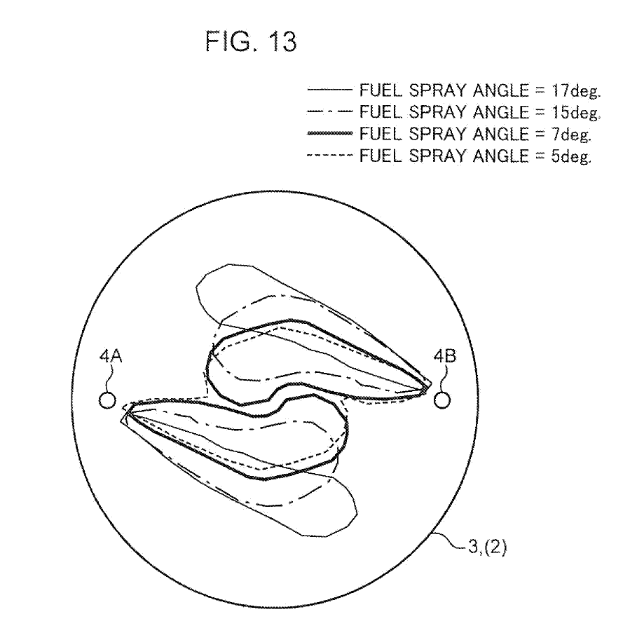

As described referring to FIG. 6, in the embodiment, the angle r1 defined by the centerline of a fuel spray (a1, a2, b1, and b2) closest to the symmetrical line SL, out of the fuel sprays to be injected from the first injection valve 4A and the second injection valve 4B, and the symmetrical line SL is set to be not smaller than 7° but not larger than 15°. According to the above configuration, as will be described later in detail referring to FIG. 13, it is not only possible to avoid concentration of fuel in the center part of the combustion chamber 3 resulting from collision between the fuel sprays a1 and a2 from the first injection valve 4A, and the fuel sprays b1 and b2 from the second injection valve 4B, but it is also possible to weaken the penetration of each of the fuel sprays, thanks to an involution phenomenon of attracting the other one (b1, b2 or a1, a2) of the fuel sprays toward one (a1, a2 or b1, b2) of the fuel sprays. This makes it possible to securely avoid strong collision of fuel sprays against the wall surface of the piston 13 as described above, and to reduce the likelihood of forming an over-rich air-fuel mixture whose fuel concentration is exceedingly high. Thus, the above configuration is advantageous in enhancing the air utilization rate to thereby effectively reduce the soot generation amount.

FIG. 13 is a diagram showing a state of fuel sprays at a point of time when a predetermined period of time has elapsed after injection of fuel at different angles from the first injection valve 4A and the second injection valve 4B. Referring to FIG. 13, the contour of a fuel spray whose fuel spray angle (the angle defined with respect to the symmetrical line SL) is 5° is indicated by the broken line, the contour of a fuel spray whose fuel spray angle is 7° is indicated by the bold solid line, the contour of a fuel spray whose fuel spray angle is 15° is indicated by the one- dotted chain line, and the contour of a fuel spray whose fuel spray angle is 17° is indicated by the thin solid line. As is obvious from these line diagrams in FIG. 13, in the case where the fuel spray angle is 5° (indicated by the broken line), the fuel sprays from the first injection valve 4A and the fuel sprays from the second injection valve 4B collide with each other, and merge with each other. This means that a large amount of fuel stays in the center part of the combustion chamber 3, and a region whose fuel concentration is remarkably high is formed in the center part of the combustion chamber 3. On the other hand, in the case where the fuel spray angle is 17° (indicated by the thin solid line), although the collision of fuel sprays as described above does not occur, the fuel sprays from the first injection valve 4A and the fuel sprays from the second injection valve 4B substantially linearly extend without interference with each other. This means that the penetration of fuel sprays from the first and second injection valves 4A and 4B is considerably strong even at a point of time when a predetermined period of time has elapsed after the injection.

In contrast, in the case where the fuel spray angle is 7° (indicated by the bold solid line) or 15° (indicated by the one-dotted chain line), the fuel sprays from the first injection valve 4A and the fuel sprays from the second injection valve 4B do not merge with each other, and collision does not occur. In addition to the above, the tip ends of fuel sprays from the first and second injection valves 4A and 4B are bent in such a direction as to cause mutual involution. Thus, the above matter also clarifies that the penetration of fuel sprays is weakened, and the injection speed is lowered.

Conceivably, the phenomenon that fuel sprays cause mutual involution is due to a pressure gradient, which is generated along the axis direction of a fuel spray. Specifically, if fuel sprays are strongly injected from the first and second injection valves 4A and 4B, the pressure increases toward downstream of the fuel sprays (in other words, the pressure decreases toward upstream of the fuel sprays). In this way, a pressure gradient along the axis direction of a fuel spray is generated. Accordingly, in the case where the fuel sprays injected from the first and second injection valves 4A and 4B come close to each other, as shown by the bold solid line or the one-dotted chain line in FIG. 13, downstream ends of the fuel sprays from one of the first and second injection valves 4A and 4B are attracted toward upstream ends (toward the low pressure side) of the fuel sprays from the other of the first and second injection valves 4A and 4B, and a phenomenon (an involution phenomenon) that the fuel sprays are bent toward the center of the combustion chamber 3 occurs. In the case where the distance between the fuel sprays is long (in other words, in the case where the fuel spray angle is large), however, a suction force resulting from a pressure difference is not generated. Accordingly, as shown by the thin solid line in FIG. 13, an involution phenomenon between fuel sprays does not occur. On the other hand, the distance between the fuel sprays is short (in other words, in the case where the fuel spray angle is small), as shown by the broken line in FIG. 13, the fuel sprays may collide with each other. As shown by the bold solid line and the one-dotted chain line in FIG. 13, the range of the fuel spray angle that makes it possible to properly generate an involution phenomenon between fuel sprays without causing the collision described above is not smaller than 7° but not larger than 15°.

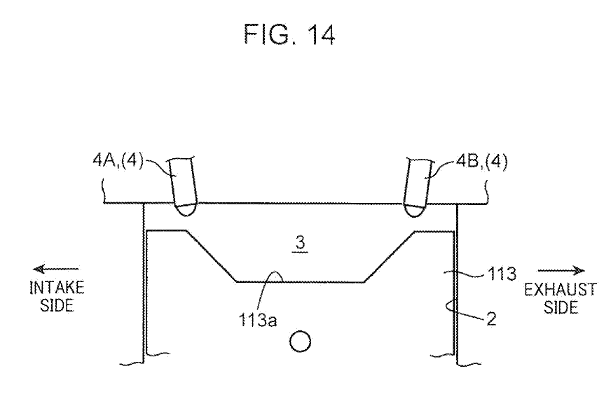

In the embodiment, as shown in FIG. 2 and FIG. 7, the piston 13 is formed with the cup-shaped cavity portion 13a having such a shape that the depth of the concave portion increases toward the center of the piston 13. The cavity portion may have various shapes other than the above, as far as the region on the top surface of the piston including the center part of the top surface is concaved. For instance, as shown in FIG. 14, a piston 113 may be configured such that a cavity portion 113a including a flat surface at a center part thereof and a tapered surface surrounding the center part is formed on a top surface of the piston 113.

Further, in the embodiment, the six injection holes 44a to 44f arranged in two rows by three columns are formed in each of the first and second injection valves 4A and 4B. The number and the position of injection holes are not limited to the above, but various modifications may be applied.

Further, in the embodiment, the penetration of fuel sprays is weakened, as the distance from the symmetrical line SL increases by setting the injection hole diameter to be smaller, as the distance from the symmetrical line SL increases. The method for varying the penetration is not limited to the above. For instance, the penetration of fuel sprays varies by changing the axial length of an injection hole (the thickness of the valve body 41 at a portion where an injection hole is formed), in place of changing the injection hole diameter. In other words, increasing the axial length of an injection hole reduces the diffusion angle of a fuel spray to be injected through the injection hole. This strengthens the penetration. Contrary to the above, decreasing the axial length of an injection hole increases the diffusion angle of a fuel spray to be injected through the injection hole. This weakens the penetration. In view of the above, it is possible to vary the penetration by changing the axial length of an injection hole, in addition to or in place of changing the injection hole diameter.

Further, in the embodiment, there are provided the first common rail 30 which stores fuel to be supplied to the first injection valve 4A while pressurizing the fuel, and the second common rail 31 which stores fuel to be supplied to the second injection valve 4B while pressurizing the fuel. Alternatively, a single common rail to be shared between the first injection valve 4A and the second injection valve 4B may be used. In the above modification, a high pressure pump which pressurizes and feeds fuel to the common rail may be a single pump which pressurizes and feeds fuel to the common rail.

Further, the embodiment has been described based on the premise that a diesel engine performs diffusive combustion such that fuel is injected from the first injection valve 4A and the second injection valve 4B at a point of time when the piston 13 is moved up near the compression top dead center position (in other words, in a state that the combustion chamber 13 is in a sufficiently high temperature state) (see the main injection Fm in FIG. 8), and the injected fuel is combusted while being mixed with air. It is not necessary to perform the above diffusive combustion in the whole operating region of the engine. The diesel engine may be configured such that premix combustion (combustion, in which fuel is injected sufficiently before the piston 13 reaches the compression top dead center position, and combustion is performed after the fuel and air are uniformly mixed) at least in part of the operating region.

It should be noted that various modifications are applicable, as far as such modifications do not depart from the gist of the invention.

### (4) Summary of Embodiment

The following is a summary of the configuration of the diesel engine disclosed in the embodiment, and the advantageous effects of the diesel engine based on the configuration.

The diesel engine is provided with a combustion chamber formed between a reciprocating piston and a cylinder head, and an injector which injects fuel into the combustion chamber from the cylinder head side for diffusively combusting the fuel injected from the injector in the combustion chamber. The injector has a first injection valve and a second injection valve disposed to face each other with respect to a center of the combustion chamber. Assuming that a straight line passing through the first injection valve and the second injection valve is a symmetrical line, one of two regions obtained by dividing a planar region of the combustion chamber into two along the symmetrical line is a first region, and the other of the two regions is a second region, the first injection valve injects the fuel toward the first region, and the second injection valve injects the fuel toward the second region. A cavity portion is formed in a region on a top surface of the piston including a center part of the top surface, the cavity portion being concave toward a side opposite to the cylinder head. Each of the first injection valve and the second injection valve is formed with at least one injection hole at a radially inner position than a periphery of the cavity portion in plan view, the injection hole serving as an exit of the fuel.

In the diesel engine having the above configuration, fuel is injected from the first injection valve and the second injection valve disposed to face each other with respect to the center of the combustion chamber toward the two regions (the first region and the second region) divided by the symmetrical line connecting the first and second injection valves. Accordingly, unlike a general diesel engine configured to inject fuel in a radial fashion from a single injection valve disposed at the center of the combustion chamber toward the periphery of the combustion chamber, the above configuration makes it possible to extend a flight distance by which the injected fuel sprays can fly, in other words, to extend the distance connecting the exit (the injection hole) of a fuel spray and the wall surface of the piston along the centerline of the fuel spray.

In particular, in the diesel engine having the above configuration, the cavity portion concave toward the side opposite to the cylinder head is formed in the top surface of the piston, and the injection holes are formed in each of the first and second injection valves at radially inner positions than the periphery of the cavity portion. This configuration makes it possible to avoid collision of fuel sprays through the injection holes against the peripheral wall surface outside of the cavity portion at a very small distance. Further, the above configuration makes it possible to let the fuel sprays injected through the injection holes to fly along the wall surface of the cavity portion. This makes it possible to extend the flight distance of fuel sprays.

As described above, securing a long flight distance of fuel sprays from the injection valves makes it possible to sufficiently atomize the fuel during flight of the fuel sprays, and thereby to weaken the penetration of the fuel sprays. Accordingly, it is possible to avoid that strong collision of fuel sprays against the wall surface of the piston results in uneven fuel distribution. As a result of the above operation, the air utilization rate in the combustion chamber is enhanced. This is advantageous in suppressing combustion in an oxygen lean environment to thereby effectively reduce the soot generation amount.

Further, the first and second injection valves are disposed at two positions facing each other on the periphery of the combustion chamber. This makes it possible to inject fuel of a desired amount in a distributed manner from the different positions, and to constantly supply air around the injection holes in the first and second injection valves by a swirl stream swirling around within the combustion chamber. Accordingly, an air shortage state in the initial stage of combustion when the fuel has just started to be injected from the first and second injection valves is eliminated, and fuel and air are sufficiently mixed. In this manner, a sufficient amount of air is secured even in an initial stage of combustion when an air shortage state is likely to occur. Thus, it is possible to achieve combustion with less soot generation and with enhanced emission performance.

In the diesel engine having the above configuration, preferably, each of the first injection valve and the second injection valve may be formed with a plurality of the injection holes, all the injection holes being arranged at radially inner positions than the periphery of the cavity portion in plan view, and the plurality of the injection holes in the first injection valve and in the second injection valve may be formed to have shapes different from each other so that penetration of fuel sprays through the injection holes differs.

According to the above configuration, fuel is injected through all the injection holes in the first and second injection valves toward the cavity portion. This makes it possible to make the fuel concentration distribution in the combustion chamber even, which is advantageous in enhancing the air utilization rate in the combustion chamber. Further, forming the injection holes to have shapes different from each other makes it possible to weak the penetration, as the flight distance to the wall surface of the piston decreases. This makes it possible to avoid strong collision of all the fuel sprays against the wall surface of the piston. Thus, the above configuration is advantageous in making the fuel distribution even to thereby effectively reduce the soot generation amount.

Specifically, in order to vary the penetration of each fuel spray, the plurality of the injection holes in the first injection valve and in the second injection valve may be formed to have hole diameters different from each other.

Further, in the above configuration, in order to weaken the penetration as the flight distance to the wall surface of the piston decreases, the plurality of the injection holes in the first injection valve and in the second injection valve may be formed such that the hole diameter of an injection hole decreases as a distance from the symmetrical line to the fuel spray through the injection hole increases.

In the above configuration, forming the injection holes to have shapes different from each other, or forming the injection holes to have hole diameters different from each other is not limited to a configuration, in which each one of the injection holes has a different shape (or a different hole diameter). For instance, in the case where there are three or more injection holes, it is possible to form injection holes having a same shape (or a same hole diameter), as far as there are formed injection holes having at least two different shapes (or at least two different hole diameters).

In the diesel engine having the above configuration, preferably, the piston may have a squish portion at a radially outer position than the cavity portion, the squish portion being formed of an annular flat surface.

According to the above configuration, it is possible to form a squish stream directing from the outer peripheral side of the combustion chamber toward the center thereof when the piston is moved up near the compression top dead center position. The squish stream is operative to push a swirl stream swirling around within the combustion chamber toward the center of the combustion chamber. This is advantageous in strengthening the swirl stream. Further, the synergetic effect of the swirl stream and the squish stream as described above promotes mixing of fuel and air to thereby further enhance the air utilization rate.

This application is based on Japanese Patent application No. 2013-018824 filed in Japan Patent Office on Feb. 1, 2013, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A diesel engine, comprising:
a combustion chamber formed between a reciprocating piston and a cylinder head; and
an injector which injects fuel into the combustion chamber from a side of the cylinder head for diffusively combusting the fuel injected from the injector in the combustion chamber, wherein
the injector has a first injection valve and a second injection valve disposed to face each other with respect to a center of the combustion chamber,
assuming that a straight line passing through the first injection valve and the second injection valve is a symmetrical line, one of two regions obtained by dividing a planar region of the combustion chamber into two along the symmetrical line is a first region, and the other of the two regions is a second region, the first injection valve injects the fuel toward the first region, and the second injection valve injects the fuel toward the second region,
a cavity portion is formed in a region on a top surface of the piston including a center part of the top surface, the cavity portion being concave toward a side opposite to the cylinder head, and
each of the first injection valve and the second injection valve is formed with at least one injection hole at a radially inner position than a periphery of the cavity portion in plan view, the injection hole serving as an exit of the fuel.

2. The diesel engine according to claim 1, wherein
each of the first injection valve and the second injection valve is formed with a plurality of the injection holes, all the injection holes being arranged at radially inner positions than the periphery of the cavity portion in plan view, and
the plurality of the injection holes in the first injection valve and in the second injection valve are formed to have shapes different from each other so that penetration of fuel sprays through the injection holes differs.

3. The diesel engine according to claim 2, wherein
the plurality of the injection holes in the first injection valve and in the second injection valve are formed to have hole diameters different from each other.

4. The diesel engine according to claim 3, wherein
the plurality of the injection holes in the first injection valve and in the second injection valve are formed such that the hole diameter of an injection hole decreases as a distance from the symmetrical line to the fuel spray through the injection hole increases.

5. The diesel engine according to claim 1, wherein
the piston has a squish portion at a radially outer position than the cavity portion, the squish portion being formed of an annular flat surface.
